(19) United States
(12) Patent Application Publication
(10) Pub. No.: US 2006/0245977 A1
(43) Pub. Date: Nov. 2, 2006

(54) Collection device for a fluid specimen

(75) Inventor: Moishe Bodner, Brooklyn, NY (US)

Correspondence Address: KAPLAN GILMAN GIBSON & DERNIER L.L.P., 900 ROUTE 9 NORTH, WOODBRIDGE, NJ, 07095, US

(73) Assignee: Saliva Diagnostic Systems Inc.

(21) Appl. No.: 11/119,546

(22) Filed: May 2, 2005

(51) Int. Cl. B01L 3/00

(52) U.S. Cl. 422/99

(57) ABSTRACT

A device for collecting a fluid specimen absorbed in an absorption pad, comprises a tube for receiving the pad. The pad is selectively secured to one of the two positions. In the first position, the pad is approximate to a bottom of the tube so that the pad can be immersed in a buffer solution for preserving the specimen. In the second position, the pas is distant from the bottom so that the fluid specimen thrown out from the pad under a centrifugal separating force will not be reabsorbed by the pad.

### BACKGROUND OF THE INVENTION

This invention relates to techniques of handling fluid specimens, and more particularly, to a collection device for fluid specimens which is simple in design and can be used during collection, storage, transportation and separation stages of the specimens. The present invention also relates to a method for conveniently separating a fluid specimen from an absorption pad.

FIGS. 1a-1d schematically illustrate the steps to collect and store a fluid specimen, such as a saliva sample. A pad 10 with a relatively wide absorption portion 10a is placed inside a mouth of a patient to collect a saliva sample, which will be absorbed into the absorption portion 10a. A connection portion 10b of the pad 10 is then connected to a cap 20, and placed in a storage tube 30 sealed by the cap 20. As illustrated in Fig. Id, the absorption portion 10a is located proximate to a bottom of the tube 30 so that it is immersed in a buffer solution 31 to preserve the saliva sample absorbed in the absorption portion 10a. The storage tube 30 with the pad 10 therein is then transported to a lab for testing the specimen.

In the lab, the saliva specimen is separated from the absorption portion 10a of the pad 10. This is usually done by applying a centrifugal force to the tube 30 after the buffer solution 31 is removed from the tube 30. Under the centrifugal force, the saliva specimen is forced out of the absorption portion 10a of the pad 10 and collected in the bottom of the tube 30. However, because the absorption portion 1Oa is located proximate to the bottom of the tube 30a, re-absorption of at least some of the saliva specimen from the bottom of the tube 30 is inevitable.

A conventional solution to avoid re-absorption of the already-separated fluid specimen is using a dual-tube system, as illustrated in FIG. 2. A hole is provided in the bottom of the storage tube 30, which is normally sealed by a nipple 33. In the lab, the buffer solution 31 (if any) is removed from the storage tube 30, and the nipple 33 is removed to open the hole 32. The storage tube 30 is then secured inside a collection tube 40, and a centrifugal force is applied to the two tubes 30 and 40. Under the centrifugal force, the fluid specimen is thrown out of the absorption portion 10a of the pad 10, and enters the collection tube 40 through the hole 32 in the bottom of the storage tube 30. However, the dual-tube system not only requires more components, but is also inconvenient in use since the nipple 33 has to be removed manually by a technician in the lab so as to open the hole 32. In an alternative solution, there is no nipple 33 to seal the hole 32. However, such a storage tube 30 cannot contain the buffer solution because of the existence of the hole 32.

Therefore, there exists a need for a solution for collecting fluid specimens which is simple in design with fewer components, is easy to use, and is capable of preventing re-absorption of the separated fluid specimen back to the absorption pad as well.

### SUMMARY OF THE INVENTION

According to a first aspect of the present invention, a novel device is provided for storing a fluid specimen absorbed in an absorption portion of a pad which comprises a container for receiving the pad therein, and means for selectively securing the pad inside the container in a first position in which the absorption portion of the pad is located approximate to a bottom of the container, or a second position in which the absorption is located distant from the bottom of the container. Thus, the absorption portion may be secured to the first position during the storage and transportation stages so as to be immersed in a buffer solution, but can be secured to the second position during the separating stage under a centrifugal force so that the specimen separated from the pad will not be reabsorbed by the pad because of the distance between the absorption portion of the pad and the bottom of the container.

According to a second aspect of the present invention, an apparatus for collecting a fluid specimen is provided, which comprises a tube having an bottom and an open end opposite to the bottom, a cap for closing the open end of the tube, and a pad having an absorption portion for absorbing the fluid specimen thereon and a connection portion connected to the cap, wherein the cap is adapted to selectively seal the open end of the tube in a first closed position or a second closed position, whereby securing the pad inside the tube in a first position in which the absorption portion is located approximate to the bottom or in a second position in which the absorption portion is located distant from the bottom. Thus, the pad can be placed in either a position approximate to the bottom or a position distant from the bottom by adjusting the cap to the two selective corresponding closed positions.

According to a third aspect of the present invention, a method is provided for processing a fluid specimen absorbed in an absorption portion of a pad received in a collection tube, which comprises a step of securing the pad inside tube in a position that the absorption portion is not located approximate to the bottom of the tube. Thus, when the fluid specimen is thrown out of the pad under a centrifugal force and collected in the bottom of the tube, re- absorption of the specimen back to the pad is prevented.

According to a fourth aspect of the present invention, a collection tube is provided for separating a fluid specimen from an absorption pad in a storage container, which comprises a bottom having a hole therein, wherein the collection tube is dimensioned such that it is suitable to be placed inside the storage container and to squeeze the fluid specimen out of the absorption pad whereby the fluid specimen separated from the pad enters the collection tube through the hole in the bottom. Thus, no centrifugal force is needed to separate the fluid specimen from the absorption pad.

According to a fifth aspect of the present invention, an apparatus is provided for processing a fluid specimen, which comprises an absorption pad for collecting the fluid specimen and absorbing the specimen therein, a storage tube for keeping the absorption pad therein, and a collection tube having a bottom with a hole therein. The collection tube is adapted to squeeze the specimen out of the pad whereby the specimen separated from the pad enters the collection tube through the hole in the bottom. No centrifugal force is needed to separate the specimen from the absorption pad.

According to a sixth aspect of the present invention, a method is provided for processing a fluid specimen, which comprises the steps of: collecting the fluid specimen with an absorption pad; storing the pad in a storage tube; placing a collection tube inside the storage tube, the collection tube having a bottom with a hole therein; and squeezing the fluid specimen out of the pad with the bottom of the collection tube whereby the fluid specimen separated from the pad enters the collection tube through the hole in the bottom. No centrifugal force is needed.

### BRIEF DESCRIPTION OF THE DRAWINGS

The above and other features and advantages will be clearer after reading the detailed description of the preferred embodiments of the present invention with reference to the accompanying drawings, in which:

FIGS. 1a-1d schematically illustrate a process of collecting and storing an oral specimen in the prior art;

FIG. 2 illustrates a dual-tube system for processing a fluid specimen in the prior art;

FIGS. 3a and 3b schematically illustrate an embodiment of the device according to the present invention;

FIGS. 4a-4c schematically illustrate an embodiment of the sealing engagement between the cap and the tube as illustrated in FIGS. 3a and 3b;

FIGS. 5a and 5b schematically illustrate another embodiment of the sealing engagement between the cap and the tube as illustrated in FIGS. 3a and 3b;

FIGS. 6a and 6b schematically illustrate a further embodiment of the sealing engagement between the cap and the tube as illustrated in FIGS. 3a and 3b;

FIGS. 7a and 7b schematically illustrate another embodiment of the device according to nt invention; and

FIGS. 8a-8c schematically illustrate a further embodiment of the device according to the present invention.

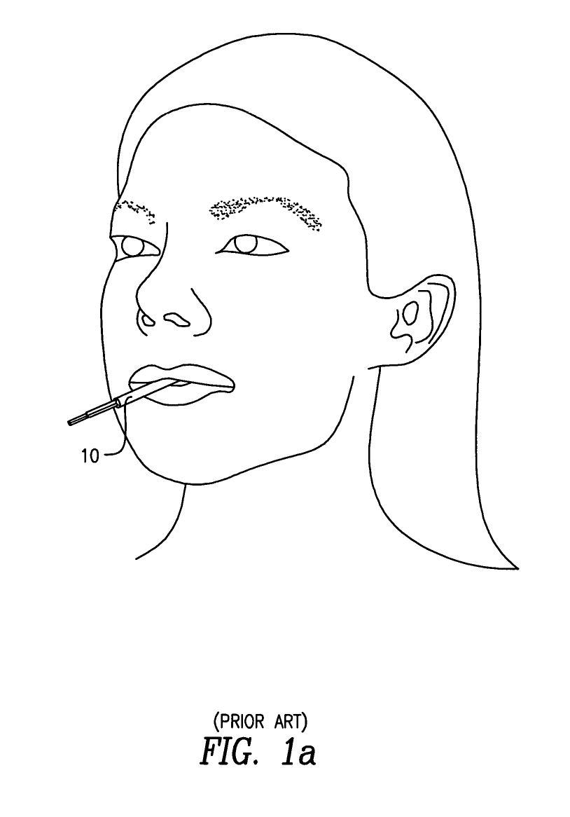

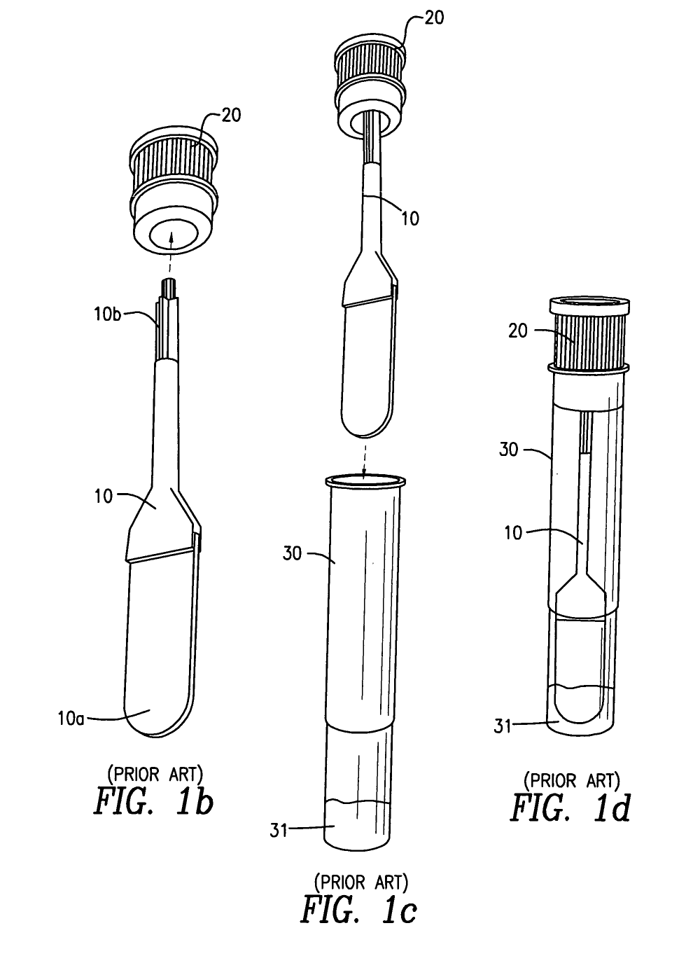

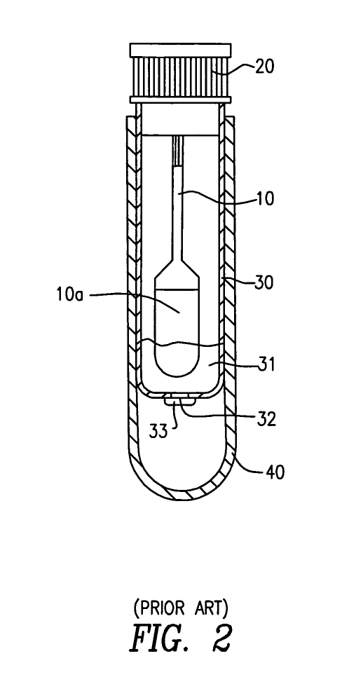

### DETAILED DESCRIPTION OF THE PREFERRED EMBODIMENTS OF THE INVENTION

The device according to the present invention generally comprises a storage tube 30 for storing an absorption pad 10 therein. A connection portion 10b of the pad 10 is connected to a cap 20 which seals an opening of the storage tube 30. An absorption portion 10a of the pad 10, with a fluid specimen (such as a saliva sample) absorbed therein, is immersed in a buffer solution 31 during storage and transportation stages for preserving the specimen.

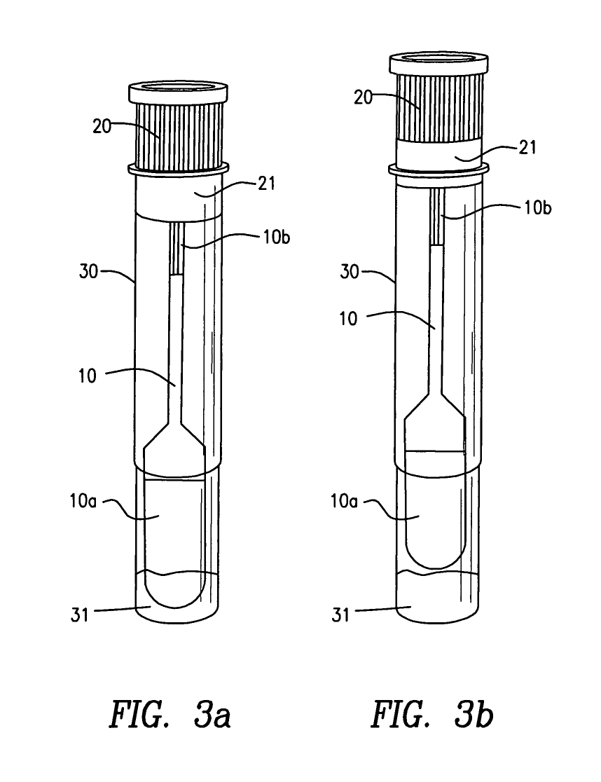

According to the teaching of the present invention, the absorption pad 10 can be selectively secured inside the storage tube 30 in two different positions as illustrated in FIGS. 3a and 3b respectively.

In the first position as shown in FIG. 3a, the absorption portion 10a is located approximate to a bottom of the storage tube 30. The pad 10 is secured in this first position during storage and transportation stages so that the absorption portion 10a can be immersed in the buffer solution 31 to preserve the specimen kept in the absorption portion 10a.

In the second position as shown in FIG. 3b, the absorption portion 10a is not located approximate to the bottom of the collection tube 30. The pad 10 is secured in this second position during a separation stage when the device is under a centrifugal force for separating the fluid specimen from the absorption pad 10a (after the buffer solution 31 is removed), so that the fluid specimen thrown away from the absorption pad 10a and colleted in the bottom of the storage tube 30 will not be reabsorbed by the absorption pad l0a because the absorption pad l0a is not close to the bottom of the storage tube 30.

According to a preferred embodiment of the present invention, the pad 10 is selectively secured in the first position (FIG. 3a) and the second position (FIG. 3b) by selectively positioning the cap 20 in different closed positions. Specifically, the cap 20 is adapted to selectively seal the tube 30 in two different closed positions as illustrated in FIGS. 3a and 3b respectively. With the pad 10 connected to the cap 20 by the connection portion l0b, when the cap 20 seals the tube 30 in the first closed position, the pad 10 is in the lower, first position as illustrated in FIG. 3a, and when the cap 20 seals the tube 30 in the second closed position, the pad 10 is brought to the higher, second position as illustrated in FIG. 3b.

According to the above embodiments, the buffer fluid may be discarded when the tube arrives at the lab, and the cap 20 may then be replaced in the position shown in FIG. 3b prior to centrifuging.

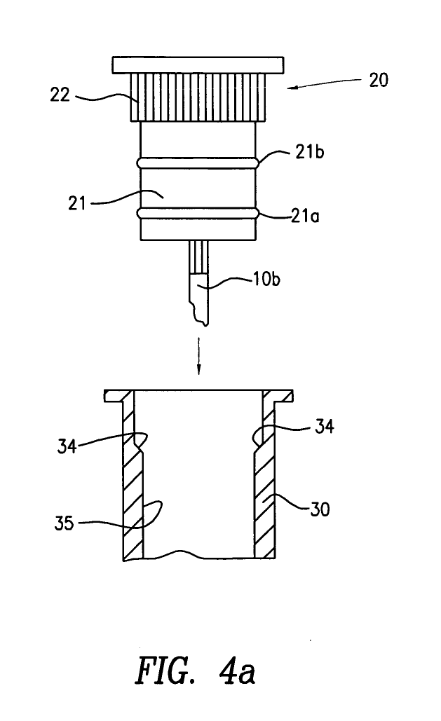

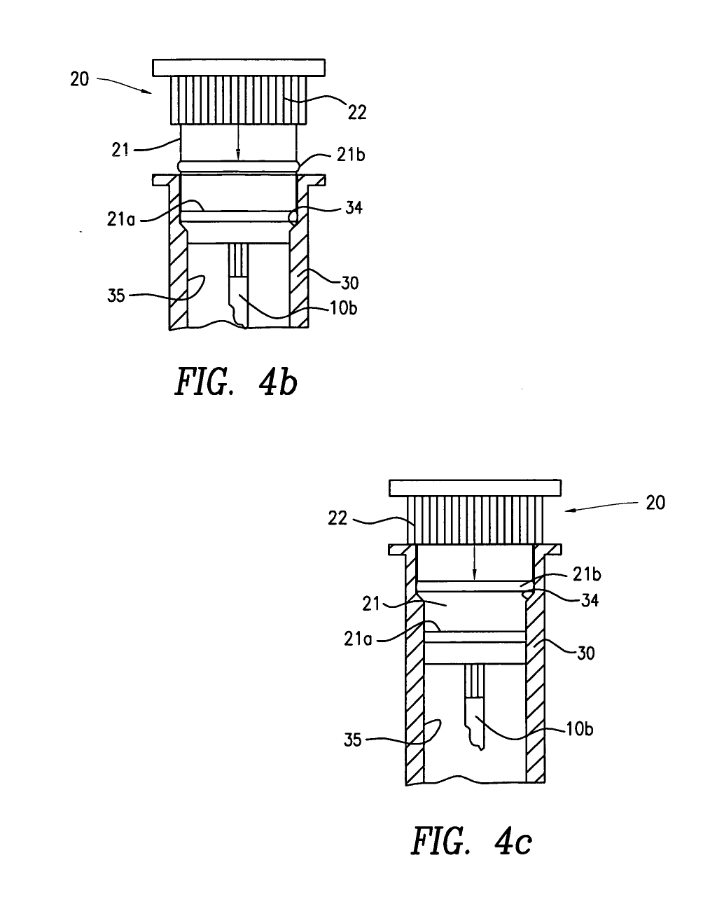

Any suitable engagement mechanism can be used for the cap 20 to selectively seal the tube 30 in the two different closed positions. FIGS. 4a-4c illustrates an embodiment of the engagement between the cap 20 and tube 30. As illustrated in FIG. 4a, the inner sidewall 35 is formed with a shoulder 34, while the outer sidewall 21 depending from the cap 20 is provided with two circular protrusions or bulging circles 21a and 21b. When the sidewall 21 enters the tube 30 to seal the tube 30 by tight-fitting engagement between the outer sidewall 21 of the cap 20 and the inner sidewall 35, the lower circular protrusion 21a meets and abuts the shoulder 34 first, whereby securing the cap 20 in the second, higher closed position, as illustrated in FIG. 4b. The cap 20 may be made of a soft material such as a plastic which allows slight deformation, thus further pressing the cap 20 will deform the lower circular protrusion 21 a and advance the sidewall 21 further into the tube 30 until the upper circular protrusion 21b abuts the shoulder 34. The cap 20 is thus secured in the first, lower closed position as shown in FIG. 4c.

The head portion 22 of the cap 20 is preferably larger than the opening of the tube so as to stop the cap 20 from moving further.

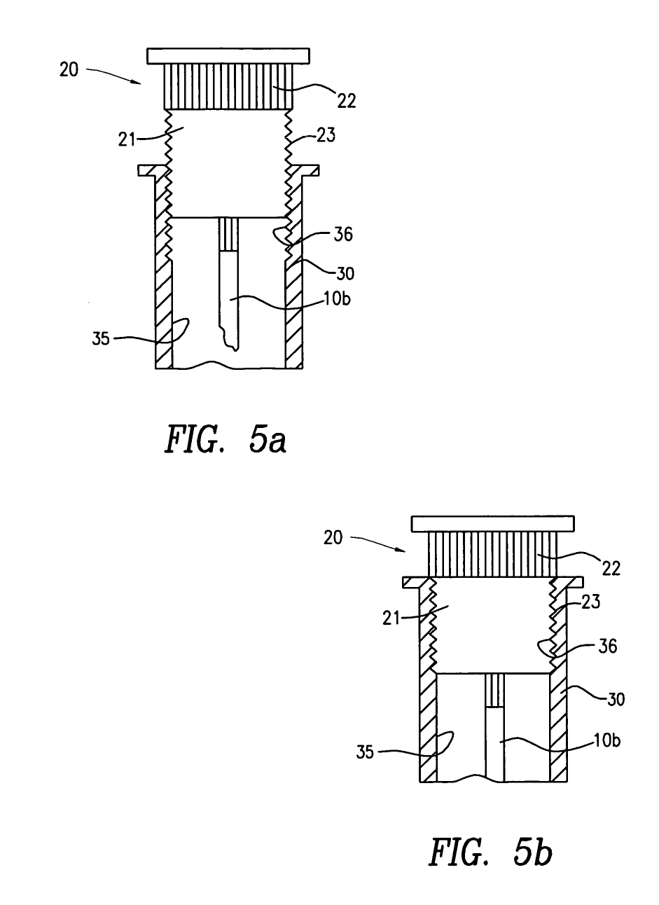

FIGS. 5a and 5b illustrate another embodiment of the engagement between the cap 20 and the tube 30. In this embodiment, a threaded connection is adopted. Specifically, matching threads 23 and 36 are provided in the outer sidewall 21 of the cap 20 and the inner sidewall 35 of the tube 30 in a portion close to the opening, respectively. By the threaded engagement, the cap 20 can be selectively moved to the first and second closed positions as illustrated in FIGS. 3a, 3b and 5b, 5a. Preferably, marking is provided on the cap 20 to indicate that the cap 20 has reached its first closed position and second closed position. For example, such marking can be provided on the sidewall 21 of the cap 20. It shall be noted that the threaded engagement may also allow the cap 20 to be secured to other positions.

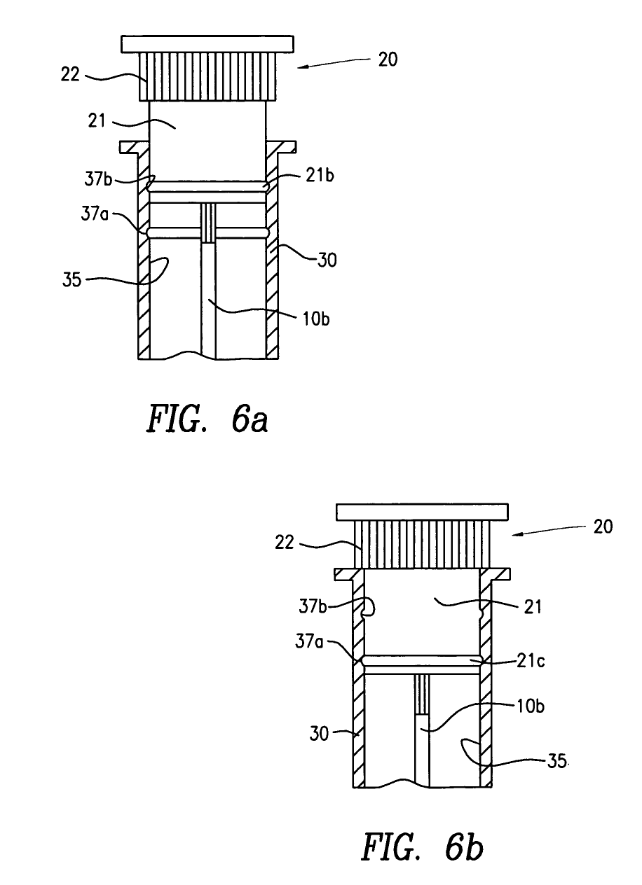

FIGS. 6a and 6b illustrate a further embodiment of the engagement between the cap 20 and the tube 30. In this embodiment, a groove-protrusion connection is used for securing the cap 20 in the first and the second closed positions. More specifically, a circular protrusion 21c is provided on the outer sidewall 21 of the cap 20, and two circular grooves 37a, 37b are provided in different locations in the inner sidewall 35. As illustrated in FIG. 6a, when the sidewall 21 enters the tube 30, the circular protrusion 21c meets and engages with the upper groove 37b first, whereby securing the cap 20 in the second, upper closed position. When the cap 20 is further pressed down into the tube 30, the somewhat resilient circular protrusion 21c is disengaged from the upper groove 37b and further moved downward until it meets and engages with the lower groove 37a, whereby securing the cap 20 in the first, lower closed position, as illustrated in FIG. 6b.

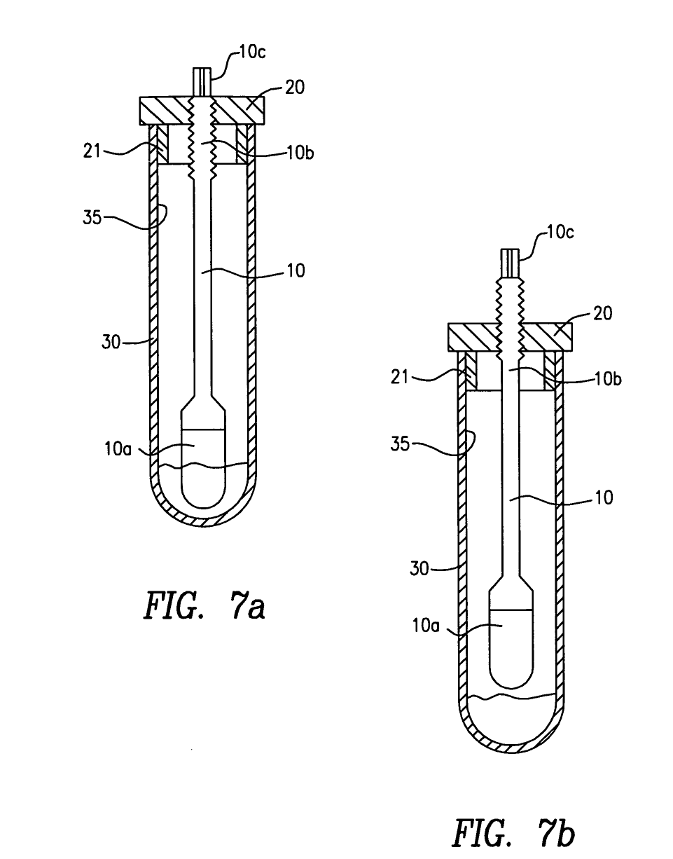

FIGS. 7a and 7b illustrated another embodiment of the device according to the present invention. In this embodiment, the pad 10 is connected to the cap 20 by an adjustable threaded connection. As illustrated in FIG. 7a, the pad 10 is connected to the cap 20 in a lower position such that the absorption portion 10a is located approximate to the bottom of the collection tube 30. In FIG. 7b, the pad 10 is connected to the cap 20 in a higher position such that the absorption portion 10a is located distant from the bottom of the tube 30. A head portion 10c is provided on the pad 10 for facilitating manual adjustment of the threaded engagement between the pad 10 and the cap 20. In this embodiment, the cap 20 seals the tube 20 in a single position by a complementary engagement between sidewalls 21, 35 of the cap 20 and the tube 30 as in the prior art.

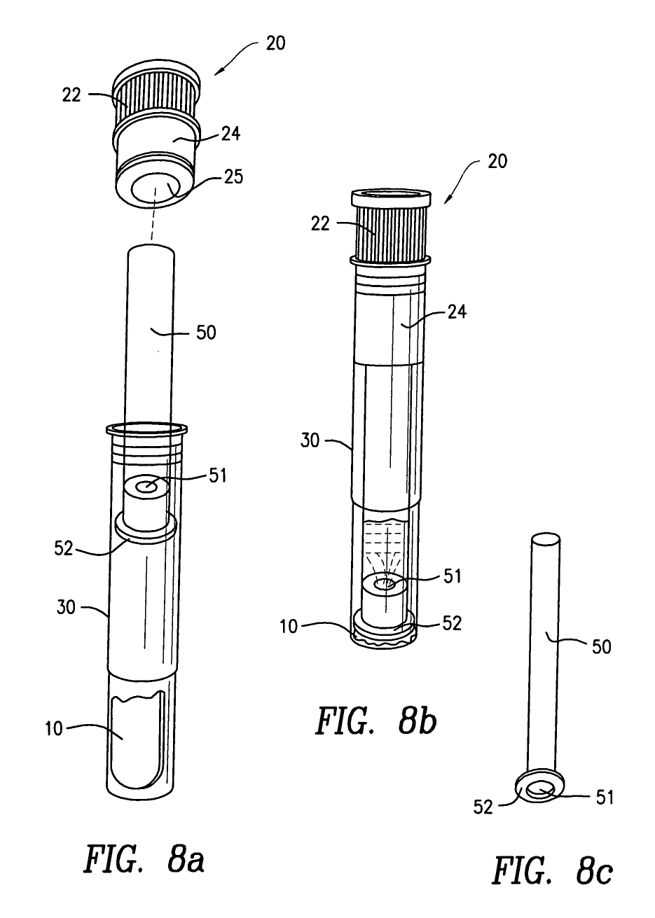

FIGS. 8a-8c illustrate a further embodiment of the device according to the present invention. In this embodiment, no centrifugal force is needed to separate the fluid specimen from an absorption pad 10. In stead, a collection tube 50 (FIG. 8c) is provided for squeezing the fluid specimen from the absorption pad 10, as best illustrated in FIG. 8b. The bottom of the collection tube 50 is provided with a hole 51, through which the fluid specimen squeezed out of the absorption pad 10 enters collection tube 50 and is collected in the tube 50.

Preferably, the bottom of the tube 50 is provided with a flange portion 52, which is preferably of the same inner size of the storage tube 30. Thus the fluid specimen squeezed out of the absorption pad 52 is prevented from moving to the space formed between the sidewalls of the two tubes 30, 50, whereby forcing the fluid specimen squeezed out of the absorption pad 52 into the collection tube 50 through the hole 51.

Preferably, the upper end of the collection tube 50 is adapted to be sealed by the cap 20 too, so that when the fluid specimen is collected in the collection tube, the cap 20 is used to seal the collection tube 50. More specifically, the cap 20 comprises a sleeve portion 24 depending from the head portion 22. The outer sidewall of the sleeve portion 24 is sized to be engageable with the inner sidewall of the storage tube 30 so as to seal the tube 30, while the inner sidewall of the sleeve portion 24 is sized to be engageable with an outer sidewall of the collection tube 50 so as to seal the collection tube 50.

Preferably, the collection tube 50 has a sufficient length such that when the cap 20 moves toward its closed position, the collection tube 50 is driven by the cap 20 to squeeze the absorption pad 10.

Preferably, a plug or nipple (not shown) is provided for sealing the hole 51 after the fluid specimen is collected in the collection tube 50. Preferably, the hole 51 is fitted with a one way valve, so that the fluid enters the collection tube 50 but may not escape. The collection tube may then

It is noticed that in this embodiment the absorption pad 10 is not attached to the cap 20. Conveniently, the absorption pad 10 may comprise a breakable handle for facilitating collecting the fluid specimen from a mouth of a patient. After the specimen is collected, the handle is broken away from an absorption portion of the pad 10, so that only the absorption portion of the pad 10 is placed in the storage tube 30. This break may occur via a weakened portion of the pad 10, so that the handle and a very small piece of the pad are torn away, and the remaining portion of the pad as shown in FIG. 8a remain within the tube 30.

Though the above has described the preferred embodiments of the present invention, it shall be understood that numerous adaptations, modifications and variations are possible to those skilled in the art without departing the gist of the present invention. For example, the complementary engagement between the cap 20 and the storage tube 30 may be an engagement between an inner sidewall of the cap 20 and an outer sidewall of the tube 30. Therefore, the scope of the present invention is solely intended to be defined by the accompanying claims.

What is claimed is:

1. A device for storing a fluid specimen absorbed in an absorption portion of a pad, comprising:
a container for receiving said pad therein; and
means for selectively securing said pad inside said container in a first position in which said absorption portion of said pad is located approximate to a bottom of said container, or a second position in which said absorption portion is located distant from said bottom of said container.

2. The device of claim 1, wherein said container is a tube with an opening opposite to said bottom.

3. The device of claim 2, wherein said securing means comprises a cap to selectively seal said opening of said tube in a first closed position or a second closed position.

4. The device of claim 3, wherein said cap is adapted to connect with said pad such that said pad is secured in said first position when said cap seals said opening in said first closed position, and said pad is secured in said second position when said cap seals said tube in said second closed position.

5. The device of claim 4, wherein said cap comprises a cover and a sidewall depending from said cover.

6. The device of claim 5, wherein said cover is adapted to connect with a connection portion of said pad opposite to said absorption portion.

7. The device of claim 6, wherein said cap is adapted to seal said opening of said tube by a complementary engagement between said sidewall of said cap and a sidewall of said tube.

8. The device of claim 7, wherein said sidewall of said cap is an outer sidewall, and said sidewall of said tube is an inner sidewall.

9. The device of claim 7, wherein said complementary engagement comprises a threaded engagement.

10. The device of claim 7, wherein said complementary engagement comprises a tight fitting engagement.

11. The device of claim 7, further comprising means for selectively and releaseably holding said cap in said first closed position or said second closed position.

12. The device of claim 11, wherein said holding means comprises a groove- protrusion engagement in both said first and second positions.

13. The device of claim 1, wherein said absorption portion of said pad is immersed in a buffer solution when said pad is secured in said first position.

14. The device of claim 1, wherein said fluid specimen is an oral fluid specimen.

15. The device of claim 14, wherein said oral fluid specimen is a saliva specimen.

16. The device of claim 1, wherein said securing means comprises a cap for covering said tube, said cap being adapted to connect with a connection portion of said pad opposite to said absorption portion.

17. The device of claim 16, wherein said cap and said connection portion of said pad is connected by an adjustable threaded connection capable of selectively securing said pad in said first portion or said second position inside said container.

18. Apparatus for collecting a fluid specimen, comprising:
a tube having a bottom and an open end opposite to said bottom;
a cap for closing said open end of said tube; and
a pad having an absorption portion for absorbing said fluid specimen thereon and a connection portion connected to said cap;
wherein said cap is adapted to selectively seal said open end of said tube in a first closed position or a second closed position, whereby securing said pad inside said tube in a first position in which said absorption portion is located approximate to said bottom or in a second position in which said absorption portion is located distant to said bottom.

19. The apparatus of claim 18, wherein said cap comprises a cover and sidewall depending from said cover.

20. The apparatus of claim 19, wherein said cap seals said open end of said tube by a complementary engagement between said sidewall of said cap and a sidewall of said tube.

21. The apparatus of claim 20, wherein said complimentary engagement comprises a threaded engagement.

22. The apparatus of claim 21, wherein said threaded engagement is capable of selectively and releaseably holding said cap in said first closed position and said second closed position.

23. The apparatus of claim 20, wherein said complimentary engagement comprises a tight fitting engagement.

24. The apparatus of claim 23, further comprising one or more groove-protrusion connections between said sidewalls to selectively and releasably hold said cap in both said first closed position and said second closed position.

25. The apparatus of claim 23, wherein said cap is larger than said open end of said tube whereby said cap is held in said first closed position when said cap abuts said open end of said tube.

26. The apparatus of claim 20, wherein said sidewall of said cap is an outer sidewall, and said sidewall of said tube is an inner sidewall.

27. A method of processing a fluid specimen absorbed in an absorption portion of a pad received in a collection tube, comprising a step of securing said pad inside said tube in a first position such that said absorption portion of said pad is not located approximate to a bottom of said tube.

28. The method of claim 27, further comprising, after said step of securing said pad to said first position, a step of applying a centrifugal force to said pad to separate said fluid specimen from said absorption portion of said pad.

29. The method of claim 27, further comprising, before said step of securing said pad in said first position, a step of securing said pad inside said tube in a second position such that said absorption portion is located approximate to said bottom of said tube.

30. The method of claim 29, further comprising, before said step of securing said pad in said first position, a step of keeping said absorption portion in a buffer solution for preserving said specimen in said absorption portion.

31. The method of claim 30, further comprising, before said step of applying said centrifugal force, a step of removing said buffer solution from said tube.

32. The method of claim 29, further comprising a step of moving said pad from said second position to said first position.

33. The method of claim 32, wherein said step of moving is carried out by changing a cap for closing an opening of said tube from a first closed position to a second closed position.

34. The method of claim 33, wherein said pad is connected to said cap.

35. A collection tube for separating a fluid specimen from an absorption pad in a storage container, comprising a bottom having a hole therein, wherein said collection tube is dimensioned such that it is suitable to be placed inside said storage container and to squeeze, with said bottom, said fluid specimen out of said absorption pad such that said fluid specimen separated from said pad enters said collection tube through said hole in said bottom.

36. Apparatus for processing a fluid specimen, comprising:
an absorption pad for collecting said fluid specimen and absorbing said specimen therein;
a storage tube for keeping said absorption pad therein;
a collection tube having a bottom with a hole therein, said collection tube being adapted to squeeze said specimen out of said pad with said bottom whereby said specimen separated from said pad enters said collection tube through said hole in said bottom.

37. The apparatus of claim 36, further comprising a plug for closing said hole after said specimen enters said collection tube.

38. The apparatus of claim 36, further comprising a cap for sealing an opening of said storage tube.

39. The apparatus of claim 38, wherein said collection tube has a length such that it is adapted to squeeze said pad against a bottom of said storage tube when said cap is in a sealed position.

40. The apparatus of claim 36, wherein said storage tube is adapted to contain a buffer solution for preserving said specimen in said pad.

41. The apparatus of claim 36, wherein said absorption pad comprises a breakable handle for facilitating collecting said specimen.

42. A method for processing a fluid specimen, comprising the steps of:
collecting said fluid specimen with a pad for absorbing said specimen therein;
storing said pad in a storage tube;
placing a collection tube inside said storage tube, said collection tube having a bottom with a hole therein; and
squeezing said fluid specimen out of said pad with said bottom of said collection tube whereby said fluid specimen separated from said pad enters said collection tube through said hole in said bottom.

43. The method of claim 42, said step of storing further comprises keeping said pad in a buffer solution.

44. The method of claim 43, further comprising a step of removing, before said step of squeezing, said buffer solution from said storage tube.

45. The method of claim 42, further comprising a step of sealing said hole after said step of squeezing.
